(19) United States
(12) Patent Application Publication
(10) Pub. No.: US 2010/0199551 A1
(43) Pub. Date: Aug. 12, 2010

(54) Arrangement Device

(76) Inventor: Christine Wargo, Dickson City, PA (US)

Correspondence Address: MITCHELL A. SMOLOW, 720 HAMPTON ROAD, SHAVERTOWN, PA, 18708, US

(21) Appl. No.: 12/596,435

(22) PCT Filed: Oct. 21, 2008
(86) PCT No.: PCT/US08/80614

§ 371 Date: Oct. 17, 2009

Related U.S. Application Data
(60) Provisional application No. 61/001,504, filed on Nov. 1, 2007.

(51) Int. Cl. A01G 5/00

(52) U.S. Cl. 47/41.13; 47/58.1 CF

(57) ABSTRACT

Arrangement device [1000] includes a plurality of apertures each tilted along a circumferential angle. The apertures are uniquely defined and designed to receive specified stems of elongated objects [301, 310] to be arranged. The apertures align the elongated objects [301, 310] according to the tilt angles of the apertures. The apertures are shaped to allow the elongated objects [301, 310] to fall to a resting position approximating how the final arrangement would appear. The apertures also have an inner wall [1302, 1312] angled to allow the elongated objects [301, 310] to meet at a gathering point [2000]. They are gathered together at a tie point [2000] and tied into a bouquet [3000] while each stem still retains the same circumferential tilt. In an alternative embodiment, overlays [1107] may be used to identify which type and color of items is to be placed in each aperture.

### CROSS REFERENCE TO RELATED APPLICATIONS

This application claims priority from U.S. Provisional Patent Application Ser. No. 61/001,504 “Arrangement Device” filed Nov. 1, 2007 by the same inventor as the present application, Christine Wargo.

### FEDERAL SPONSORED RESEARCH

Not Applicable

### SEQUENCE LISTING OR PROGRAM

Not Applicable

### BACKGROUND OF THE INVENTION

1. Field of the Invention

The present invention relates to a device for arranging flowers and other aesthetic decorations.

2. Discussion of Related Art

Flower arrangement is a large business in the US and elsewhere. The selection of flowers and other vegetation, the angular and spatial separation and relative heights are important in providing an aesthetically pleasing product.

Also, it is important to be able to accurately produce the same arrangement repeatedly. It is also important to be able to accurately reproduce a given arrangement remotely at a different location. This would be important for national dealers of flowers which advertise and sell the flowers at one location which are intended to be sent to a recipient at another remote location. A floral shop near the recipient creates the arrangement and delivers it to the recipient. The delivered arrangement should look very similar to the one which the buyer bought.

Finally, it is important to be able to reproduce a given arrangement in a cost-effective manner. A device or tool which allows for rapid and consistent creation of an arrangement requiring little knowledge would be beneficial.

There are known devices for holding flowers and other similar arrangements described in U.S. Pat. No. 3,087,280 Sellinger, U.S. Pat. No. 6,457,276 Masters and U.S. pending patent application Ser. No. 09/826,983 Masters.

Sellinger shows a very simple arrangement with one row of coils encircling a central wire coil. This is intended to hold arrangements, but does not act as a tool to insure consistent creation of arrangements.

Also, since it is constructed of wire coils, the stems are not easily inserted or extracted since leaves and protrusions on the stems get caught on the wire coils. These are designed to replace a vase.

The Masters patent and the Masters patent application both are designed for holding arrangements. They are not designed to provide for consistent reproducible arrangements. They also are not designed to act as an arrangement tool.

U.S. Pat. No. 7,213,365 Van Zuylen describes a device for inserting flower stems in a grating to a bottom plate then twisting the stems to make an arrangement. Since the stems of flowers are placed through the grating to a bottom plate, and must be twisted, they are positioned in the grating vertically. If they were offset in various angles, they may become broken or tangled as they are twisted.

It is difficult to get a feeling of how the relative flower head spacing would be in the finished product if they are all positioned vertically.

There are no indications of identifying specific holes and therefore no way to exactly identify flower locations.

Currently, there is a current need for a device which acts as a tool to allow inexperienced users to quickly and efficiently produce arrangements with a high degree of accuracy and efficiency.

### SUMMARY OF THE INVENTION

One embodiment of the present invention is an arrangement device 1000 for creating aesthetic arrangements comprising:
a) a plurality of apertures for receiving elongated items intended to be arranged, each aperture angled in a predefined circumferential angle;
b) an identification code to uniquely identify each aperture; and
c) instructions indicating the contents of each aperture.
The arrangement device may also be embodied wherein the apertures are arranged in a plurality of rings having overlays providing instructions as to what is to be placed in each aperture.

### OBJECTS OF THE INVENTION

It is an object of the present invention to provide a decorative arrangement device which aids in creating arrangements in a pre-defined manner.

It is another object of the present invention to provide a decorative arrangement device which aids in creating arrangements repeatedly in a pre-defined manner.

It is another object of the present invention to provide a decorative arrangement device which directs a user to create arrangements in a pre-defined manner.

It is another object of the present invention to provide a decorative arrangement device which arranges flowers for use in a hand-held bouquet.

It is another object of the present invention to provide a decorative arrangement device which allows one to create specific arrangements at a remote location.

It is another object of the present invention to provide a decorative arrangement device which allows one to create numerous arrangements in a cost-efficient manner.

It is another object of the present invention to provide a decorative arrangement device which allows one to create arrangements with the stem ends of flowers being arranged immersed in water.

It is another object of the present invention to provide a decorative arrangement device which allows one to create dry arrangements in without the use of water.

It is another object of the present invention to provide a decorative arrangement device which teaches an inexperienced user how to create specific arrangements.

It is another object of the present invention to provide a decorative arrangement device which allows one with little knowledge of floral arrangement to create professional-quality arrangements.

### BRIEF DESCRIPTION OF THE DRAWINGS

The advantages of the instant disclosure will become more apparent when read with the specification and the drawings, wherein:

FIG. 1 is a perspective view of one embodiment of the arrangement device according to the present invention.

FIG. 2 is a side cross-sectional view of the arrangement device of FIG. 1 indicating how flower stems would be arranged in the device.

FIG. 3 is a partial side elevational view of a single row of apertures of the arrangement device of FIGS. 1, 3 as viewed 90 degrees away from the view of FIG. 2.

FIG. 4 is a cross-sectional view of another embodiment of the arrangement device according to the present invention.

### DETAILED DESCRIPTION OF THE INVENTION

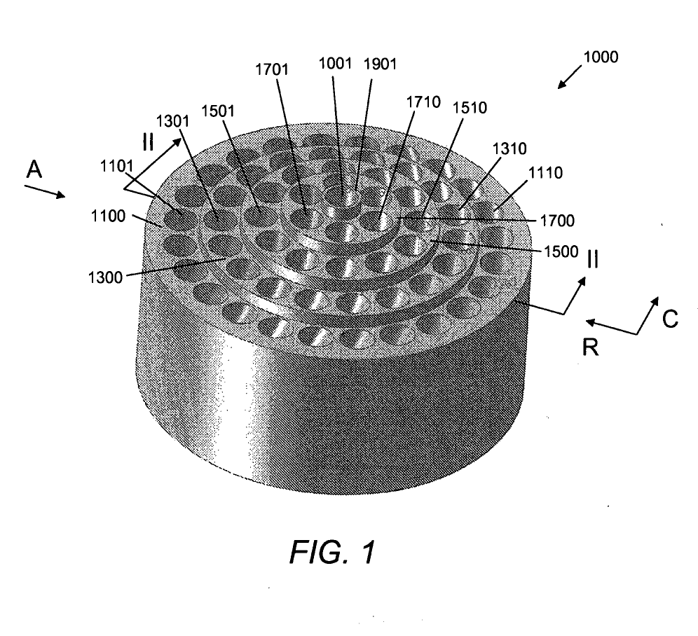

FIG. 1 is a perspective view of one embodiment of the arrangement device according to the present invention.

Arrangement device 1000 has a plurality of apertures for receiving items intended to be arranged which may be flowers, vegetation, or other elongated aesthetically pleasing items. The embodiment described below relates to arranging flowers and related items collectively referred to as “flowers”. However, it is to be understood that this arrangement device works well to arrange other elongated items arranged for ornamental purposes.

Also, please note that the embodiment shown has radial symmetry, but may be a number of other shapes which all fall under the spirit of the invention.

Arrangement device 1000 employs a plurality of apertures for receiving the stems of the flowers. In this embodiment, these apertures are arranged in concentric rings where apertures 1101, 1110 are in ring 1100, apertures 1301, 1310 are in ring 1300, apertures 1501, 1510 are in ring 1500, apertures 1701, 1710 are in ring 1700 and 1901 is a center aperture. In this embodiment, each ring is slightly higher moving toward a center 1001 of arrangement device 1000. However, other embodiments having different geometries are possible which fall under the spirit of the invention.

It is understood that the apertures may be packed in other ways which are not rings.

In a preferred embodiment, each of the apertures is given a unique identifier such that the contents of each may be individually specified.

The stems of flowers are inserted into the apertures according to a pre-determined arrangement. Since each aperture may be marked with a unique identification number, the contents of each aperture may be uniquely identified in a set of instructions for a given bouquet.

The location of each flower head is a function of the angle of the aperture in which it was placed and the length of the stem.

Each aperture is positioned to have its top end tilt in a direction following a circle around center 1001 relative to its bottom end. This will be referred to as a “circumferential tilt”. The circumferential tilt adds a more professional look to bouquets.

The arrow marked “C” indicates the circumferential direction, being a direction along a circle centered on center point 1001.

The arrow marked by the letter “R” indicates a radial direction.

Each aperture is also shaped to allow the stems and flowers to lean away from the center 1001 during arrangement, to a maximum leaning angle, but toward the center 1001 to another maximum angle when being tied, without losing the circumferential tilt.

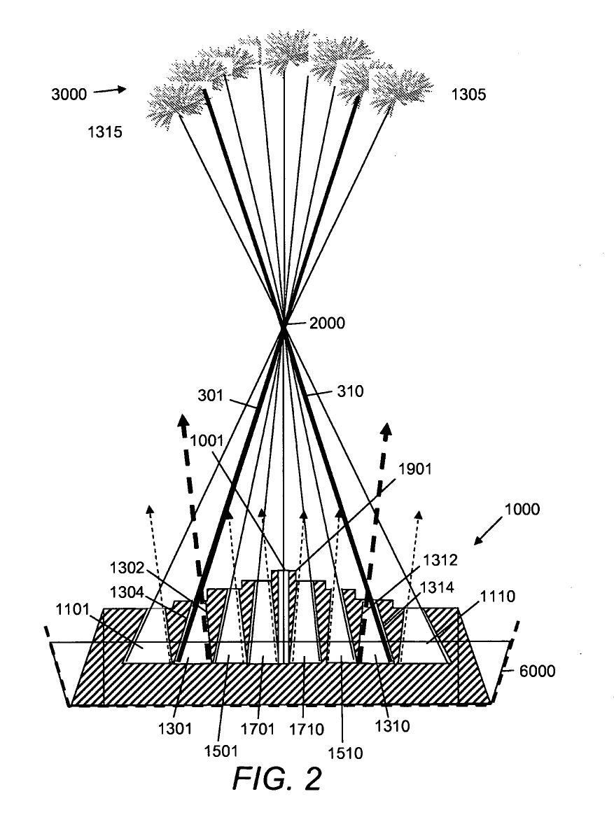

FIG. 2 is cross-sectional, side elevational view of the arrangement device of FIG. 1.

Since this is a side view of a row of apertures, the circumferential tilt out of the page toward the reader for apertures 1101, 1301, 1501, 1701 on the left is not visible. Similarly, the circumferential tilt of apertures 1710, 1510, 1310, 1110 into the page and away from the reader are also not visible.

Apertures 1101, 1301, 1501, 1701, 1710, 1510, 1310, 1110 in this embodiment are shaped having a wider base side and a narrower top side in this view. Center aperture 1901 may have a cylindrical shape.

These apertures may extend through the entire arrangement device 1000 or only partially extend through it.

Take, for example, apertures 1301, 1310. During arrangement of the flowers, a stem 301 indicated by the thickened dashed line, is placed in aperture 1301 and a stem 310 also indicated by a thickened dashed line, is placed in aperture 1310. The flower tops (not shown) are allowed to fall under their natural weight radially outward from center 1001 where the stems rest on inner surfaces 1302, 1312, respectively at their maximum outward angle. This allows a user to get an indication of the relative spacing of the flower heads, their angular positions and how a bouquet 3000 will look when finished.

After the stems are placed in the proper apertures, they are gathered at a tie point 2000. The stems are gathered keeping approximately the same circumferential angle, however, the stems 301, 310 will now move from their resting position against the inner surfaces 1302, 1312 to the outer surfaces 1304, 1314, respectively, to their maximum inward angle. This causes flower tops 1305 and 1315 to be positioned as shown.

The outer surfaces 1304, 1314 are preferably angled to point to the tie point 2000.

Therefore, stems are allowed to tilt in a radial from their resting positions to the tie point 2000; however, they are restrained to retain their same circumferential tilt. Each stem will have the same circumferential tilt which gives bouquet 3000 a more professional look.

The arrangement device 1000 is made of a material which allows it to be placed in a container 6000 having water so that the stems may be kept moist during the arrangement.

The device 1000 may also be used with dry items, such as silk flowers, without using container 6000 and water.

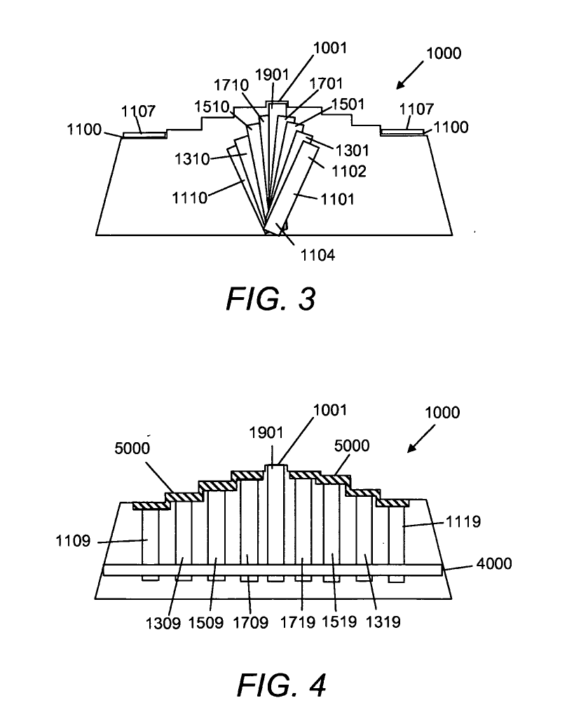

FIG. 3 is a partial side elevational view of a few tubes of the arrangement device of FIG. 1 as viewed 90 degrees away from the view of FIG. 2. The view for FIG. 3 is along the arrow marked “A” in FIG. 1.

Apertures 1101, 1301, 1501, 1701, 1901, 1710, 1510, 1310, 1110 are shown eclipsing each other. This shows how each aperture has the top of the aperture tilting in a circumferential direction (a “twist angle”) around the perimeter of arrangement device 1000. In this embodiment each ring has progressively less of a twist angle moving from ring 1100 to center point 1001.

The arrangement device 1000 will now be described in connection with FIGS. 1, 2 and 3. The arrangement device 1000 is preferably constructed having the desired number of apertures arranged in multiple rings 1100, 1300, 1500, 1700. Preferably, each aperture is angled in a circumferential angle along the arrow marked “C” of FIG. 1, around the circumference of the device.

The stems are then removed from arrangement device 1000 to result in a final bouquet 3000 having the proper angular arrangement. The oval or elongated bottom of the apertures allows for easier removal of the bouquet once it has been tied.

In order to more specifically define a bouquet, overlays may be employed and placed on top of rings 1100, 1300, 1500, 1700. In this embodiment, they would be overlays having holes which line up with the apertures. In this embodiment, these will be flat and ring-shaped. The ring has an additional hole to fit with a protrusion to allow the ring to fit only in one specific way.

In FIG. 3 an overlay 1107 is shown in cross section resting upon ring 1100.

Each overlay is specific to a given bouquet or bouquets. Each has an indication at each aperture of the type of flower which is to be placed into this aperture, or if there is to be nothing placed in this aperture. In some cases, apertures may be covered to indicate that they are not used for a given bouquet. Other information may be indicated, such as the preferred length of the stem. Also, a color may be identified to show the color of the flower to be used in this aperture.

This results in an exact identification of an arrangement specifying the flower types, the locations in which they are placed, the proper radial angles, the proper circumferential angles and the spacing.

By using the same arrangement device 1000 at a remote location with the same overlays, one may almost exactly reproduce a given arrangement.

In another embodiment, the apertures may be identified by a unique code. This may for example be by ring number and clock position or other encoding. Once defined, instructions may be made using these codes for defining a universal method of identifying flowers to exactly reproduce a given arrangement. This, theoretically, can be done by using the arrangement device 1000 and defined codes without the necessity of seeing the original arrangement. This would be useful for floral wire services for remote processing and delivery of a floral arrangement.

This allows a remote user to create almost the exact bouquets as the models at the base location. This is very important to teleflorists. Teleflorists typically show a model arrangement or a picture of one at a base location. The customer would like the same arrangement as the model delivered to a recipient at a remote location. The florist at the remote location, using the present invention and the instructions for a given bouquet, can easily create the same bouquet at the remote location.

FIG. 4 is a side elevational view of another embodiment of the present invention. In this embodiment, each of the apertures is constructed as a tube 1109, 1309, 1509, 1709, 1719, 1519, 1319, 1119 having a lower end which fits into a base plate 4000. The upper end of each tube then fits into a rotation plate 4000. Rotation plate 5000 is allowed to rotate about the center point 1001 for a limited amount. Therefore, the circumferential angle of the tubes may be set for creating unique arrangements.

The present invention may also include instructions for bouquets in which defined flowers are designated to be placed in apertures which are designated by the overlays, or imprinted upon the arrangement device 1000 itself. The overlay or the arrangement device may also have colors in the instructions or on the overlay near each aperture indicating the color of the flower which will be inserted in the aperture. Therefore, the device may be realized as an instructional device for allowing an inexperienced person to exactly create a specific bouquet accurately and efficiently.

In the embodiment of FIG. 4, the tubes may be color coded to indicate the color of a flower to be inserted into the tube.

In still another embodiment, the apertures or tubes could be cylindrical shaped with a cylindrical diameter large enough to allow the flowers to fall into the resting position, then allowing the stems to be gathered at the tie point 2000. This embodiment is less effective and does not function as well as the preferred embodiment.

In still another embodiment, apertures/tubes further from the center allow the flowers to tilt radially outward further than the apertures/tubes closer to the center.

The present invention therefore is a significant advancement over the prior art. It allows flower arrangements to be constructed in a specified manner with little or no ambiguity. Exact bouquets can be created and reproduced in an efficient and accurate manner by those with little experience in floral arrangement.

Professional results are accomplished with little experience or knowledge required by the user. It can also provide the same bouquet repeatedly with little variation making it very reproducible.

Since other modifications and changes varied to fit particular operating requirements and environments will be apparent to those skilled in the art, the invention is not considered limited to the example chosen for the purposes of disclosure, and covers all changes and modifications which do not constitute departures from the true spirit and scope of this invention.

What is claimed is:

1. An arrangement device [1000] having a center point [1001] for creating aesthetic arrangements of elongated objects [301, 310] comprising:
a plurality of apertures each capable of receiving and holding said elongated objects [301, 310], and each having an upper end [1102] and a lower end [1104], the upper end [1102] of the at least one aperture being tilted in a circumferential angle substantially along a circle around said center point [1001].

2. The arrangement device [1000] of claim 1 wherein the circumferential angle of the at least one aperture [1001] may be adjusted to create different arrangements.

3. The arrangement device [1000] of claim 1 wherein the upper end [1002] of at least one of the apertures also being tilted with respect to the lower end [1104] inward substantially toward the center point [1001].

4. The arrangement device [1000] of claim 1 wherein each aperture is wide enough to allow the elongated objects [301, 310] in the apertures to fall radially outward and also allow the elongated objects [301, 310] to be pulled together.

5. The arrangement device [1000] of claim 1 wherein each aperture is identifiable.

6. The arrangement device [1000] of claim 1 wherein each aperture has been marked with an identifier.

7. The arrangement device [1000] of claim 5 further comprising instructions identifying which elongated objects [301, 310] to put in each of the identifiable apertures.

8. The arrangement device [1000] of claim 7 wherein the instructions also indicate the length of the objects in each of the identifiable apertures.

9. The arrangement device [1000] of claim 1 wherein the apertures further comprise:
an outer wall [1304, 1314] and an inner wall [1302, 1312], the upper end [1102] of at least one aperture being tilted in a circumferential angle substantially along a circle around said center point [1001].

10. The arrangement device [1000] of claim 9, wherein the outer wall [1304, 1314] slopes radially outward toward its lower end [1104].

11. The arrangement device [1000] of claim 9, wherein the inner wall [1302, 1312] slopes radially inward toward its lower end [1104].

12. The arrangement device [1000] of claim 9, wherein the apertures the same distance from the center point [1001] have the same radial angle.

13. The arrangement device [1000] of claim 9, wherein the radial angle of the apertures increases as they get closer to the center point [1001].

14. The arrangement device [1000] of claim 9, wherein the radial angle of the apertures decreases as they get closer to the center point [1001].

15. An arrangement device [1000] for creating aesthetic arrangements comprising:
a) a plurality of apertures for receiving elongated items [301, 310] intended to be arranged, each aperture angled in a predefined circumferential angle;
b) an identification code to uniquely identify each aperture; and
c) arrangement instructions indicating the contents of each aperture.

16. The arrangement device of claim 15 wherein the apertures are arranged in a plurality of rings [1100,1300,1500,1700] having overlays [1107] providing instructions as to what is to be placed in each aperture.

17. A method of accurately arranging elongated objects [301, 310] into a bouquet [3000] at a remote location which is substantially the same as a model bouquet at a base location comprising the steps of:
a) providing an arrangement device [1000] with identifiable apertures to a base;
b) identifying the type of elongated object [301, 310] and the length of each elongated object for each of the apertures of the model bouquet at the base location as arrangement instructions;
c) providing an identical arrangement device [1000] at the remote location;
d) forwarding the arrangement instructions to the remote location;
e) at the remote location, acquiring the elongated objects [301,310] defined in the arrangement instructions;
f) at the remote location, cutting the elongated objects [301,310] to the length identified in the arrangement instructions;
g) at the remote location, inserting the cut elongated objects [301,310] in the specific apertures as stated in the arrangement instructions;
h) at the remote location, tying together the elongated objects [301,310] in the apertures; and
i) removing the tied elongated objects [301,310] to create a bouquet [3000] substantially the same as the model bouquet at the base.
